(19) United States
(12) Patent Application Publication
(10) Pub. No.: US 2004/0118625 A1
(43) Pub. Date: Jun. 24, 2004

(54) Minibike that emulates adult mototcycle and that includes remote control disengagement mechanism and auxiliary support wheels

(76) Inventor: Scott W. Witthun, Reeseville, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/326,562

(22) Filed: Dec. 20, 2002

(51) Int. Cl. B62M 7/00

(52) U.S. Cl. 180/219

(57) ABSTRACT

A minibike has a number of mock accessories affixed to it for creating the illusion of an adult motorcycle. In one embodiment, the minibike is outfitted with a “chopper” style seat, back-rest, seat-cushioning springs, and a chopper style front fork. It also includes a mock headlight attached to the front of the minibike; a set of mock taillights; a mock tachometer; a mock speedometer; and a mock gas tank. Another embodiment includes all of the foregoing features but with the exception of the chopper style seat, back-rest and front fork. Each embodiment includes a pair of detachable auxiliary training wheels. Each embodiment also includes a remote control device which allows for remote supervision of the minibike operator. The remote control device consists of a hand-held control unit and a remotely actuated “kill” switch which breaks the electrical contact to the electrical supply of the minibike.

This application claims the benefit of U.S. Provisional Patent Application No. 60/341,917 filed on Dec. 19, 2001.

### FIELD OF THE INVENTION

This invention relates to minibikes of the type that are used by young people for recreational purposes. More particularly, it relates to several embodiments of a minibike that is configured to include multiple mock accessories and devices, thereby creating the emulation of an adult motorcycle in the minibike. The present invention also relates to such a minibike that is so configured and that is also fitted with removable wheels, such wheels being provided for assisting the driver in his or her balancing of the minibike when the wheels are attached. The present invention also relates to such a minibike that is so configured and that is fitted with a remotely controlled device for disengaging the minibike as such is desired or required by a parental spectator, the spectator utilizing a hand held control for that purpose.

### BACKGROUND OF THE INVENTION

Minibikes have long been used by youngsters for on-the-road and cross-country riding enjoyment. With the resurgence of interest in the sport of motorcycling, and the evolution of the sport as one in which all family members can participate in, youngsters are particularly interested in riding a minibike that “looks like dad's.” But, in reality, the parents want a minibike which may have the outward appearance of an adult motorcycle but which is a much safer motored vehicle for that youngster.

In the experience of this inventor, one such safety feature would be to insure that the driver and the minibike remain upright at all times during operation. This safety feature would avoid an accidental “lay-down” of the minibike during its operation and the concomitant injury that can result from such a lay-down. Such a safety feature would also build the confidence of the youngest drivers in the minibike itself and in their ability to drive the minibike, thereby gaining much needed experience in the safe operation of minibikes and the sport of motorcycling in general.

Another safety feature would insure that the motor of the minibike be stoppable or “killed” by a parent or observer when the parent or observer sees that the youngster-driver is in imminent danger of colliding with an object or is simply going too far afield with the minibike and out of the “safety zone” from the parental observer's viewpoint.

Accordingly, it is an object of the present invention to provide a new and useful minibike that is fitted with a number of mock or “dummy” instruments to create the illusion that the user is driving something that appears to be very close to an adult motorcycle. It is yet another object of the present invention to provide such an outfitted and decorated minibike that is, in actuality, much safer for use by youngsters than is a conventional minibike. It is still another object of the present invention to provide such a minibike that has attached to it a pair of removable training wheels for insuring that the minibike and the driver avoid situations where the minibike is tipped over onto its side. It is yet another object of the present invention to provide such a minibike that has a remote control which allows for remote parental supervision of the minibike and the minibike rider.

### SUMMARY OF THE INVENTION

The present invention has obtained these objects. It provides for a minibike which has a number of mock or “dummy” instruments affixed to it for creating the illusion of an adult motorcycle. In one embodiment of the minibike of the present invention, the minibike is outfitted with a “chopper” style seat and back-rest, complete with seat-cushioning springs, as well as a chopper style front fork. The minibike of the present invention also includes a mock headlight attached to the front of the minibike; a set of mock taillights attached to the rear of the minibike; a mock tachometer, a mock speedometer and a mock gas tank, all situated forward of the minibike's seat and on the minibike frame; a fully enclosed chain drive between the minibike engine and the rear wheel sprocket; and a pair of retractable foot rests extending from the minibike frame.

Another embodiment of the minibike of the present invention includes all of the foregoing features of the first embodiment but with the exception of the chopper style seat, back-rest and front fork. Both embodiments are designed to be much safer for use by youngsters than conventional minibikes. This is because each minibike embodiment of the present invention has attached to it a pair of detachable auxiliary training wheels for insuring that the minibike and the driver avoid situations where the minibike is tipped over onto its side. The training wheels are easily and readily detached from the minibike frame when such is desired or required. Each minibike embodiment of the present invention also has, as optional equipment, a remote control device which allows for remote parental supervision of the minibike and the minibike rider. The remote control device consists of a hand-held control unit and a remotely actuated “kill” switch which breaks the electrical contact to the electrical supply of the minibike.

The foregoing and other features of the device of the present invention will be further apparent from the detailed description which follows.

### BRIEF DESCRIPTION OF THE DRAWINGS

FIG. 1 is a top and left side perspective view of a first embodiment of a minibike constructed in accordance with the present invention.

FIG. 2 is a partial and enlarged top plan view of the first embodiment of the minibike shown in FIG. 1.

FIG. 3 is a partial and enlarged right side elevational view of the minibike shown in FIGS. 1 and 2.

FIG. 4 is a partial and further enlarged rear elevational view of the minibike shown in FIGS. 1 through 3.

FIG. 5 is a front and left side perspective view of a second embodiment of a minibike constructed in accordance with the present invention.

FIG. 6 illustrates the remote control use of the minibike shown in FIG. 5.

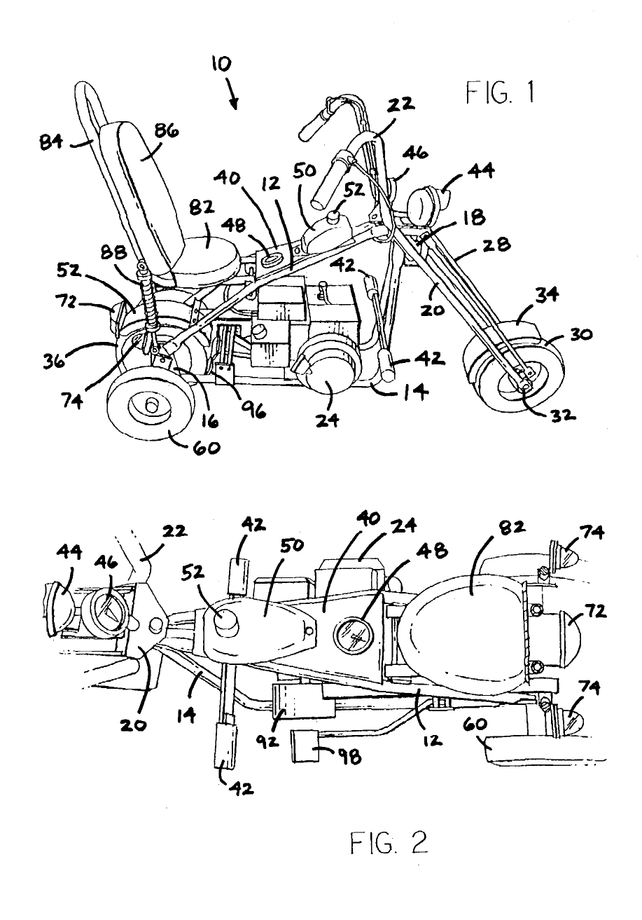

### DETAILED DESCRIPTION

Referring now to the drawings in detail wherein like numerals represent like elements throughout, FIG. 1 illustrates a first embodiment, generally identified 10, of a minibike constructed in accordance with the present invention. The minibike 10 of the first embodiment includes a pair of upper frame members 12 and a pair of lower frame members 14. The forward most portion of the upper and lower frame members 12, 14 are attached to a front frame coupling portion 18. Rearwardly of the minibike 10, the upper and lower frame members 12, 14 are attached to a pair of rear frame support plates 16. The rear frame support plates 16 are sufficiently spaced apart so as to allow a rear wheel 36 having a rear wheel axle 38 to be affixed between the support plates 16. Attached to the front frame 18 is a front steering fork 20. The upper most portion of the front steering fork 20 includes a pair of conventional handle bars 22. Extending downwardly from the front steering fork 20 is a pair of auxiliary forks 28. The front steering fork 20 of this first embodiment is configured in the fashion of a “chopper” style front fork. This configuration emulates that of an adult counterpart which is styled in the fashion of a classic chopper motorcycle. The lower most portion of the front steering fork 20 includes a front wheel 30 which is supported by a front wheel axle 32.

Extending between the upper frame members 12 of the minibike 10 is a generally horizontally situated plate 40. Affixed to the upper most portion of the plate 40 is a mock gasoline tank 50, complete with a tank fill cap 52, and a mock tachometer 48. The mock tank 50 and fill cap 52 are realistically configured to appear to be real or fully functional. Forwardly of the mock gas tank 50 is a mock speedometer 46 which extends upwardly and between the handle bars 22 of the steering fork 20. The mock speedometer 46 and the mock tachometer 48 are located within the rider's field of view in such fashion as to further enhance the illusion of real and fully functional equipment. The lower frame members 14 of the minibike 10 support a conventional two-stage gasoline powered engine or motor 24. The lower frame members 14 of the minibike 10 also include a pair of foldable footrests 42. The foldable footrests 42 similarly emulate those used on adult motorcycles.

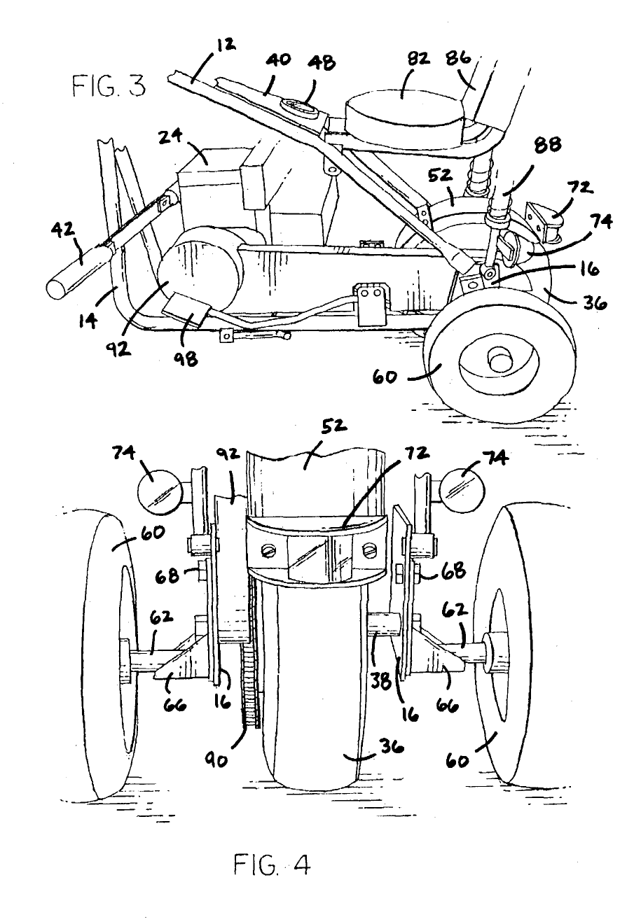

Towards the rear of the upper frame members 12 is a seat frame 84. The seat frame 84 of the minibike 10 is also configured in the “chopper” style and includes a full cushioned seat 82 and backrest 86. The seat frame 84 is supported by a pair of compressible springs 88. The springs 88 extend between the seat frame 84 and the rear frame support plate 16. Extending outwardly from each of the rear frame support plates 16 of the minibike 10 is an auxiliary wheel 60 supported by an auxiliary wheel axle 62. An auxiliary wheel bracket 66 supports each auxiliary wheel axle 62 and is removably attachable to the rear frame support plate 16 by means of bolts 68 or other suitable fasteners. See FIG. 4.

The rear wheel 36 is covered at its upper most portion by a rear wheel fender 52. A similar fender 34 covers the upper most portion of the front wheel 30 at the front steering fork 20. The front fork 20 of the minibike 10 also includes a mock headlight 44. Similarly, the rear wheel fender 52 includes a mock brake taillight 72 and mock turn signals 74. Again, these elements are added to enhance the notion that the young driver is riding a version which is every bit as impressive as the adult counterpart.

The minibike 10 of the present invention also includes a drive chain 90 which is almost completely enclosed by a drive chain cover 92. See FIG. 3. This feature adds safety in that the pants leg or other piece of clothing or attire worn by the young driver is unable to be grabbed by the drive chain 90. The minibike 10 is stoppable by means of a foot brake 96 which is functionally adapted to engage the rear tire 36 by a pressure force. The foot brake 96 is engageable by the driver by means of a foot pedal 98 which is situated to one side of the minibike 10.

The minibike 10 further includes a handheld remote control “kill” switch mechanism which is mounted so as to break the electrical contact to the electricity supply of the motor 24. The kill switch 100 itself is actuated by a remotely held control 102. See FIG. 6. In the preferred embodiment of the minibike 10 of the present invention, the remote control 102 emits radio waves or signals which are received by the kill switch 100. In response to a preprogrammed scheme, the kill switch 100 is activated by the remote control 102 when such is desired or required for the purpose of stopping the powered movement of the minibike 10 by the operator and effectively overriding the operator's control of the minibike 10. This is accomplished by effectively “piggy backing” the kill switch 100 to the operator's ablility to stop the minibike 10 as well. As previously discussed, this could be when the young driver appears to be in imminent danger of running the minibike 10 into an object, when the driver is traveling too fast for conditions or experience, or the driver is simply wandering too far afield for the comfort of the observer. Additionally, and if the remote control 102 is unavailable, the operator, or anyone else for that matter, cannot start the minibike 10.

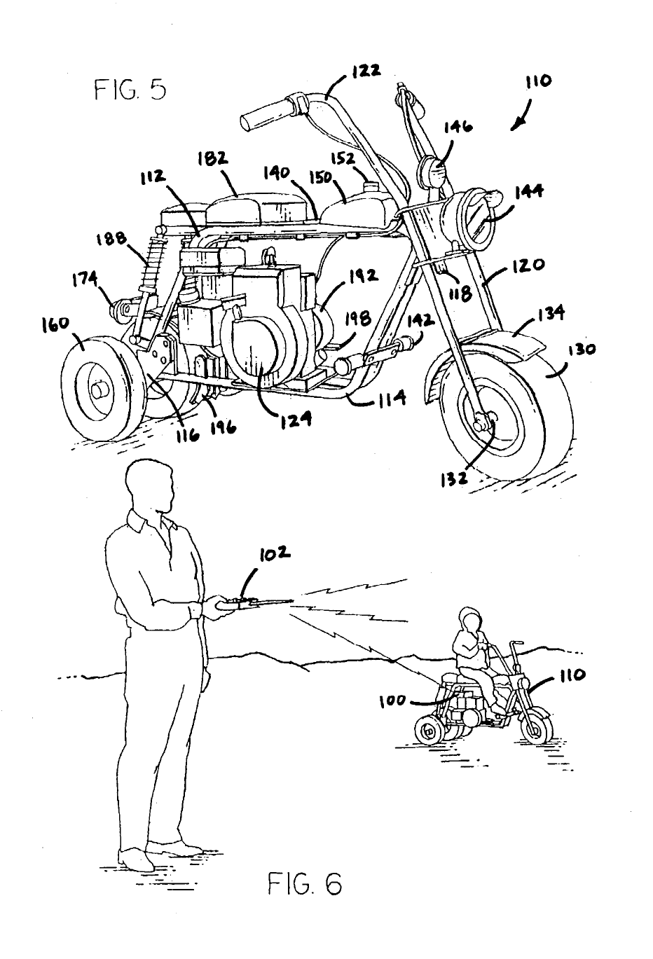

FIG. 5 illustrates a second embodiment, generally identified 110, of a minibike which is also constructed in accordance with the present invention. The minibike 110 of this second embodiment includes a pair of upper frame members 112 and a pair of lower frame members 114. The forward most portion of the upper and lower frame members 112, 114 are attached to a front frame coupling portion 118. Rearwardly of the minibike 110, the upper and lower frame members 1 12, 114 are attached to a pair of rear frame support plates 1 16. As with the first embodiment, the rear frame support plates 116 are sufficiently spaced apart so as to allow a rear wheel 136 having a rear wheel axle 138 to be affixed between the support plates 116. Attached to the front frame 118 is a steering fork 120. The upper most portion of the steering fork 120 includes a pair of handle bars 122. The lower most portion of the steering fork 120 includes a front wheel 130 which is supported by a front wheel axle 132. A front fender 134 covers the upper most portion of the front wheel 130 at the front steering fork 120.

Extending between the upper frame members 112 is a plate 140. As was the case with the first embodiment, affixed to the upper most portion of the plate 140 is a mock gasoline tank 150, complete with a tank fill cap 152, and a mock tachometer 148. Forwardly of the tank 150 is a mock speedometer 146 which extends upwardly and between the handle bars 122 of the steering fork 120. The lower frame members 114 of the second embodiment of the minibike 110 support a conventional two-stage gasoline powered engine or motor 124. The lower frame members 114 also include a pair of foldable footrests 142. The foldable footrests 142 emulate those used on adult motorcycles. Towards the rear of the upper frame members 112 is a seat frame 184. The seat frame 184 includes a full cushioned seat 182. Unlike the first embodiment, this minibike 110 does not include a backrest. The seat frame 184 is supported by a pair of springs 188. The springs 188 extend between the seat frame 184 and the rear frame support plate 116. Extending outwardly of each rear frame support plate 116 is an auxiliary wheel 160 supported by an auxiliary wheel axle 162. The rear wheel 136 is covered at its upper most portion by a rear wheel fender 152. The front fork 120 also includes a mock headlight 144. The rear wheel fender 152 includes a mock brake taillight 172 and mock turn signals 174. The minibike 110 of the second embodiment also includes a drive chain (not shown) which is enclosed by a drive chain cover 192. The minibike 110 is stoppable by means of a foot brake 196. The foot brake 196 is engageable by means of a foot pedal 198. The minibike 110, as was true of its counterpart, includes a handheld remote control “kill” switch mechanism which is mounted so as to break the electrical contact to the electricity supply of the motor 124, as previously described.

From the foregoing detailed description of the preferred embodiment of the invention set forth herein, it will be apparent that there has been provided a new and useful minibike that is fitted with a number of mock or “dummy” instruments to create the illusion of an adult motorcycle; which minibike is safer for use by youngsters than conventional minibikes; which minibike has attached to it a pair of detachable training wheels for insuring that the minibike and the driver avoid situations where the minibike is tipped over onto its side; and which minibike has a remote control which allows for remote parental supervision of the minibike and the minibike rider.

The principles of this invention having been fully explained in connection with the foregoing, I hereby claim as my invention:

1. A minibike for recreational use which comprises
a frame,
an engine, said engine being mounted to the frame,
a front steering fork, said front steering fork including a front wheel and handle bars,
a rear wheel,
a drive mechanism for transferring mechanical energy from the engine to the rear wheel whereby the minibike is movable under its own power, and
a plurality of mock accessories attached to the minibike whereby the minibike emulates an adult motorcycle.

2. The minibike of claim 1 wherein the front fork is configured in the style of an adult chopper motorcycle.

3. The minibike of claim 1 including a seat and backrest that is configured in the style of an adult chopper motorcycle.

4. The minibike of claim 1 wherein the mock accessories attached to the minibike include one or more of a mock headlight, a mock tail light, mock turn signals, a mock speedometer, a mock tachometer and/or a mock gas tank, each configured in the style of an accessory that is part of an adult motorcycle.

5. The minibike of claim 1 further including a pair of foldable foot rests and a pair of seat cushioning springs, said foot rests and springs being configured in the style of those used on an adult motorcycle.

6. The minibike of claim 1 including a pair of auxiliary wheels situated adjacent to one side or the other of the rear wheel, or to each side of the rear wheel, whereby vertical stability of the minibike is maintained.

7. The minibike of claim 1 including means for stopping the engine during use.

8. The minibike of claim 7 wherein the engine stopping means includes a mechanical kill mechanism that may be used by the minibike operator and an electronic kill mechanism that may be used remotely by an observer of the minibike operator.

9. The minibike of claim 8 wherein said electronic kill mechanism is remotely controlled from the minibike by use of a radio wave transmitter and a radio wave receiver that is attached to a part of the minibike.

10. The minibike of claim 9 wherein the electronic kill mechanism can be used to prevent starting of the minibike by the operator.

11. A minibike for recreational use that emulates an adult motorcycle, comprising
a frame,
an engine, said engine being mounted to the frame,
a front steering fork, said front steering fork including a front wheel and handle bars,
a rear wheel,
a drive mechanism for transferring mechanical energy from the engine to the rear wheel whereby the minibike is movable under its own power,
a plurality of mock accessories attached to the minibike, said mock accessories including one or more of a mock headlight, a mock tail light, mockturn signals, a mock speedometer, a mock tachometer and/or a mock gas tank, each configured in the style of an accessory that is part of an adult motorcycle, and
means for stopping the engine during use.

12. The minibike of claim 11 wherein the front fork is configured in the style of an adult chopper motorcycle.

13. The minibike of claim 11 including a seat and backrest that is configured in the style of an adult chopper motorcycle.

14. The minibike of claim 11 further including a pair of foldable foot rests and a pair of seat cushioning springs, said foot rests and springs being configured in the style of those used on an adult motorcycle.

15. The minibike of claim 11 including a pair of removable auxiliary wheels situated adjacent to one side or the other of the rear wheel, or to each side of the rear wheel, whereby vertical stability of the minibike is maintained.

16. The minibike of claim 1 1 wherein the engine stopping means includes a mechanical kill mechanism that may be used by the minibike operator and an electronic kill mechanism that may be used remotely by an observer of the minibike and its operator.

17. The minibike of claim 16 wherein said electronic kill mechanism is remotely controlled from the minibike by use of a radio wave or radio signal transmitter and a radio wave or radio signal receiver, said radio wave or radio signal receiver being attached to a part of the minibike to break the electrical connection to the engine.

18. The minibike of claim 17 wherein the electronic kill mechanism can be used to remotely prevent starting of the minibike.
